(19) United States
(12) Patent Application Publication
(10) Pub. No.: US 2001/0054090 A1
(43) Pub. Date: Dec. 20, 2001

(54) Information extraction agent system for preventing copyright infringements and method for providing information thereof

(76) Inventors: Suk Tae Jung, Inchun (KR); Chang Hak Lee, Inchun (KR); Joong MIN Choi, Kungki-do (KR); Jae Young Yang, Jeollabuk-do (KR)

Correspondence Address: Otto O. Lee, Esq., Intellectual Property Law Goup, 12 South First Street, Suite 1212, San Jose, CA, 95113, US

(21) Appl. No.: 09/881,999

(22) Filed: Jun. 14, 2001

(30) Foreign Application Priority Data
Jun. 14, 2000 (KR) 2000-32789

(51) Int. Cl. G06F 15/16

(52) U.S. Cl. 709/219; 709/202; 709/218

(57) ABSTRACT

The present invention relates to an information extraction agent system that provides information to users who request information searches, and is a method to provide information thereof.

In present invention, the user connects to a wrapper server and requests an information search. Next, wrappers regarding the user who made the request, a web robot, and wrapper interpreter capable of interpreting the wrappers and outputting an outcome to the user web browser are transferred to the user web browser. Then, user's desired information is collected from web sites by using the web robot in the user web browser. Thereafter, a form is outputted from the processed and collected information.

The present information extraction agent system wrapper server only provides information extraction rules and not information. Hence, it may avoid copyright infringement issues that might arise when the wrapper server uses other companies' web sites' digital contents.

### BACKGROUND OF THE INVENTION

The present invention relates to an information extraction agent system for providing information to users who request information searches and method for providing information thereof, and more particularly to an information extraction agent system for providing digital contents existing on numerous web sites of other companies to users who request information searches and method for providing information thereof without copyright infringements.

Search engines such as www.yahoo.com, www.lycos.com, and the like are used to search sites having information that users want from the Internet.

However, such search sites only provide a sites list containing key words inputted prior to users' searches and hyperlinks to the sites, and not for providing concrete information and materials that the users want.

Other search engines called information extraction agent systems are different from the above mentioned general search engines. They collect contents containing concrete information that users want and provide a processed form of collected contents to the users as a search result.

The information extraction agent systems employ wrappers in order to efficiently and precisely provide users with the information. A wrapper can be defined as a set of rules for recognizing and extracting information users want from information sources. The wrapper is stored in a wrapper database, and interpreted by wrapper interpretation software to extract information from each information source based on the rules. The wrapper is made in an automatic or manual mode, and performs differently in accordance to the person who makes the wrapper. That is, a manager or a wrapper designer should create a level where the wrapper interpretation software can understand how much, what type, and from what location to fetch the information by directly visiting information sources for information extraction.

A more concrete description for such a wrapper is disclosed in “Wrapper Introduction for Information Extraction” made public by Nicholas Kushmerick in 1997 and printed in “Ph.D. Dissertation, Department of Computer Science & Engineering, Univ. of Washington”, and, hereinafter, the functions and operation of the wrapper will be described in detail while explaining conventional information extraction agent systems.

FIG. 1 is a block diagram schematically showing a structure of such a conventional information extraction agent system.

The conventional information extraction system comprises: a user web browser 10, an information provider 20, and a wrapper server 30, which controls the providing of the information a user wants from the information provider 20, to the user. Here, the information provider 20 means the numerous web sites of other companies that contain the information users want. Further, the wrapper server 30 includes: a wrapper generator 40, a wrapper database 50, a wrapper interpreter 60, an outcome generating means 70, and a web robot 80.

Hereinafter, a process for searching and providing information in the conventional information extraction agent system will be described. First, a user connects to a site of the wrapper server 30, then inputs and transfers search conditions and the like to the wrapper server 30 to get desired information by using the user web browser 10.

The wrapper interpreter 60 in the wrapper server 30 locates a list of the information provider 20 to provide related information based on the search conditions inputted by the user, and the wrapper regarding the corresponding information provider 20 is extracted from the wrapper database 50. The wrapper in the wrapper database 50 exists for every information provider.

Desired digital contents are then collected from the information provider 20 by using the web robot 80. Output files are produced based on the wrapper through the wrapper interpreter 60, and the output files are displayed on the user web browser 10 by the output generator 70 in a processed form. The wrapper generator 40 are used when a wrapper server administrator updates the wrapper regarding a new information provider 20.

In a conventional information extraction agent system, all computations are done in a wrapper server, and the wrapper server directly fetches materials such as digital contents that are located at different information providers or web sites of other companies and provides them to the user. When viewing materials processed in the wrapper server, the user does not realize that the information is provided from the web sites of other companies and instead regards the wrapper server to be an information provider of the corresponding information.

Lots of materials provided on the Internet have explicit copyright indications. The copyrights regarding materials on the Internet may be identified with unique identification numbers such as the digital object identifier (DOI) . Information regarding digital contents owners and providers is inputted in the DOI, so copyright owners can be protected and illegal duplications can be prevented by automatically tracing the distribution channels of contents.

However, in the conventional information extraction agent system, by processing and providing information to users without explicit indications that other information providers offer the digital contents, the copyrights regarding the digital contents of other companies are infringed. Copyright infringements do not occur when a user opens and views contents by directly searching other information providers' web sites materials, but the conventional system constitutes copyright infringements because the wrapper server, having commercial purposes, offers the digital contents of other information providers to users without permission. Providing materials fetched by web robots from other companies without permissions causes problems in relation to the copyright. Problems of these types may lead to lawsuits, and raise serious future problems given how the Internet and the enhancement of recognitions regarding digital contents copyright is developing.

### SUMMARY OF THE INVENTION

In order to solve problems of copyright infringement as stated above, a novel information extraction agent system and a method for providing information thereof according to the present invention is necessary. Such information extraction agent system and method must provide users with a wrapper which contains information extraction rules, a wrapper interpretation means, an outcome generating means, and a web robot instead of a wrapper server's extraction of actual information from respective information providers, enabling the user to directly deal with the materials of the respective information providers. Hence, unlike conventional technology where the wrapper server becomes the center of the computation, the individual users become the wrapper server and thereby overcome the problem of the copyright infringements regarding the digital contents on the Internet.

Further, in the present invention, though a user becomes an active object and the computations are performed in the user's web browser, the user does not need to recognize such facts and accompanying jobs, since materials the user wants appears on the user's web browser as an output file of automatically searched and processed information.

In order to achieve the above objects, the method of the present invention for providing users with information on the Internet, having a user web browser, one or more information providing web sites, and a wrapper server for controlling providing of the information the users want from the information providing web sites to the users, comprises the following steps:

(a) receiving an information search request of a user and extracting wrappers regarding the user who makes the request from a database in which wrappers are stored;

(b) transferring the wrappers regarding the user who makes the request, a web robot, and a wrapper interpreter capable of interpreting the wrappers and outputting an outcome to the user web browser;

(c) collecting the information the user wants from the information providing web sites by using the web robot in the user web browser; and

(d) making the collection information an outcome of a processed form and providing the outcome to the user by using the wrappers and the wrapper interpreter.

Further, when the user inputs information providing web sites the user wants to search and information on the information providing web sites the user wants does not exist in the wrappers in step (a), the following steps are undertaken:

updating the wrappers with respect to the information providing web sites in which the information does not exist; and

storing the updated wrappers in the wrapper database.

### BRIEF DESCRIPTION OF THE DRAWINGS

The above objects and other advantages of the present invention will become more apparent by describing in detail a preferred embodiment thereof with reference to the attached drawings, in which:

FIG. 1 is a block diagram for schematically showing a structure of a conventional information extraction agent system;

FIG. 2 is a block diagram for showing a hardware structure of a wrapper server according to the present invention;

FIG. 3 is a block diagram for conceptually showing a structure of the information extraction agent system according to the present invention;

FIG. 4 is a flow chart for showing an information providing process of an information extraction agent system according to a first embodiment of the present invention;

FIG. 5 to FIG. 9 are views for showing output screens appearing on a user web browser as an example of an information providing process of the information extraction agent system according to a first embodiment of the present invention; and

FIG. 10 is a flow chart for showing an information providing process of an information extraction agent system according to a second embodiment of the present invention.

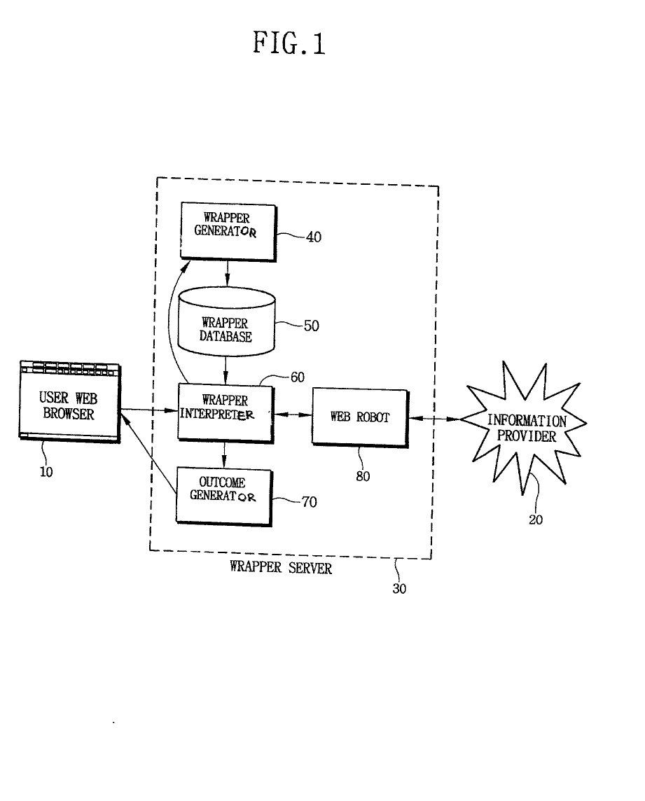

### DETAILED DESCRIPTION OF THE PREFERRED EMBODIMENT

Hereinafter, a preferred embodiment of the present invention will be described in detail with reference to the accompanying drawings.

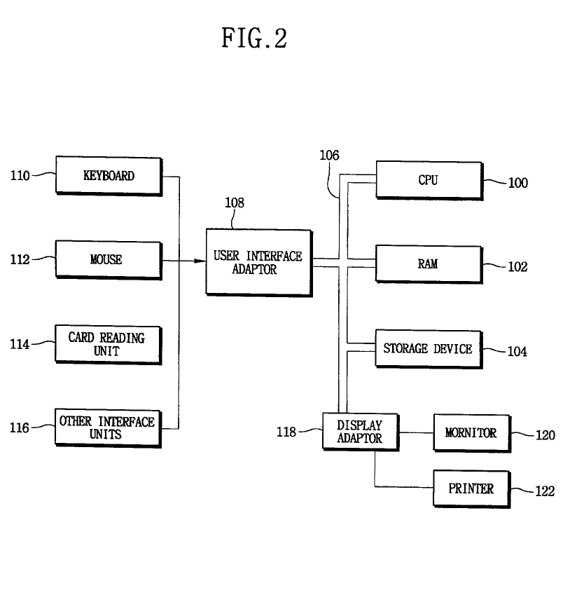

FIG. 2 is a block diagram for showing a hardware structure of a wrapper server according to an embodiment of the present invention.

A wrapper server according to the present invention includes a central processing unit (CPU) 100 and a bus 106 to enable communications between the CPU 100 and other constituents. The bus 106 connects RAM 102 and a storage device 104 to the CPU 100. Further, the wrapper server includes a user interface adapter 108 that connects one or more interface units such as a keyboard 110, a mouse 112, a card-reading unit 114, and other interface units 116 to the CPU 100 through the bus 106. Further, the wrapper server includes a display adapter 118 that connects one or more display devices such as a monitor 120 and a printer 122 to the CPU 100 through the bus 106.

Programs for providing a function of the information extraction agent system according to the present invention, which will be described hereinafter, are stored in the storage device 104 and performed by the CPU 100. The storage unit 104 in which the programs according to the present invention are stored can be in various forms such as diskettes, hard discs, CD ROMs, and so on.

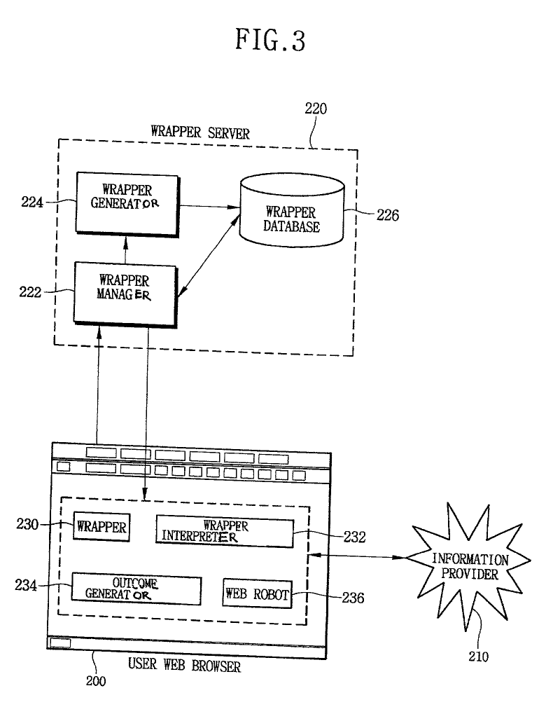

FIG. 3 is a block diagram for conceptually showing a structure of the information extraction agent system according to the present invention. The information extraction agent system according to the present invention includes a user web browser 200, an information provider 210, and a wrapper server 220, which controls providing the user with information the user wants from the information provider 210. As in the conventional arts, the information provider 210 here is a group of numerous web sites of other companies which contain the information the user wants.

The wrapper server 220 according to the present invention also includes a storage device including a wrapper database 226, a wrapper manager 222 including a request receiver for receiving an information search request of the user and extracting a set of wrappers regarding the user who makes the request from a database in which the wrappers are stored, a transferor for transferring the wrappers regarding the user who makes the request, a web robot, and a wrapper interpreter capable of interpreting the wrappers and outputting an outcome to a user web browser, and an information collector for collecting the information the user wants from the information providing web sites by using the web robot in the user web browser, a wrapper generator 224 for generating a new wrapper and updating the wrapper, and a wrapper storage.

The present invention is different from the conventional arts in that the wrapper interpreter 232, the web robot 236, and the outcome generator 234 are provided on the user web browser after a user's information request. This will be described below with a flow chart.

The wrapper manager 222, the wrapper generator 224, the wrapper 230, the wrapper interpreter 232, the outcome generator 234, the web robot 236, and so on, shown in FIG. 3 are programs stored in the user storage device 104 of FIG. 2. The connection relation as shown in FIG. 3 is provided as an example, and it should be understood that the programs can be combined to each other in any form.

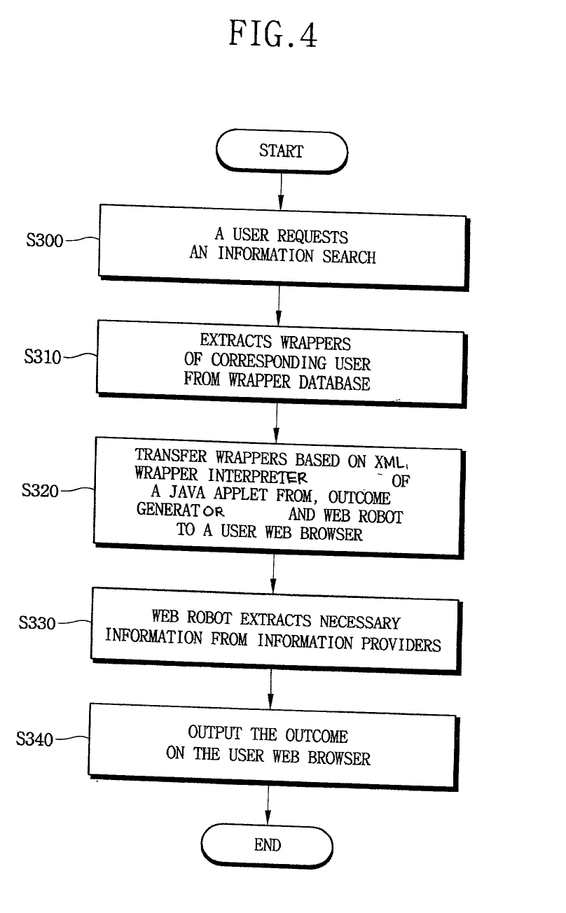

FIG. 4 is a flow chart for showing an information providing process of the information extraction agent system according to the first embodiment of the present invention.

First, a user is connected to the wrapper server 220 of the information extraction agent system through the user web browser 100 and requests an information search by inputting search conditions and the like regarding the information he/she wants (S300).

Next, the wrapper regarding the user who requests the information search is extracted from the wrapper database 226 by the wrapper manager 222 (S310). In the conventional arts, a wrapper is produced one by one for every information provider, as stated above. However, in the present invention, the wrapper is produced one by one for every user. That is, if a user is registered to a site of information extraction agent system, a wrapper of initial values which are basically established in a wrapper server for every search category (for example, real estates, electronic products, cosmetics, and so on) is made for the registered user. After this, as the user repeats the search several times, a wrapper of a developed form that contains distinctive information regarding the tendency, preference, and level of the user continues to be updated. The wrapper regarding a particular user, which is so updated, participates in a more effective information extracting and proving process together with the search conditions the user inputs upon requesting the information search.

If the wrapper regarding the particular user is extracted as a result of the user's information search request, the wrapper 230 of the particular user based on the XML, wrapper interpreter 232 of a java applet form, outcome generator 234, and the web robot 236 are transferred from the wrapper server 220 to the user web browser 200 (S320) . Here, the wrapper interpreter 232, outcome generator 234, and web robot 236 are the programs composed by using the java language.

The java language supports the moving code in the web, which is called Applet. Accordingly, when using the Applet, the programs have the mobility to be transferred from the wrapper server 220 to the user web browser 200.

After the transfer, in the user web browser 200, the kinds of information the user wants are collected in real time from the information provider 210 by using the web robot 236 (S330) . Here, the information collected by the web robot 236 is in a form of entire pages of the web document. After this, in the user web browser 200, the information collected by the wrapper 230, wrapper interpreter 232, and outcome generator 234 is outputted on the user web browser 200 as an output of a form interpreted and processed according to the rules (S340). Here, the wrapper 230 and wrapper interpreter 232 perform functions of extracting only parts of information necessary for the user out of the entire page form of the web document collected by the web robot 236. With the above process, the information providing process by means of the information extraction agent system according to the present invention is completed.

A remarkable point in the above process is that the process of collecting and providing digital contents from the information provider 210 is performed on the user web browser 200 rather than the wrapper server 220. In the information extraction agent system according to the present invention, since the wrapper server 220 does not provide direct information but only information extraction rules (wrapper), the wrapper server 220 does not deal directly with the information of the actual information providers (web sites of other companies) . Accordingly, potential copyright infringement matters that may take place when an information extraction agent system server (that is, a wrapper server) for commercial purposes uses the digital contents of the web sites of other companies without permission, do not occur.

Hereinafter, an example of the search for the information on real estate for sale will be described to illustrate how the information providing process of the information extraction agent system according to the first embodiment actually appears to the user.

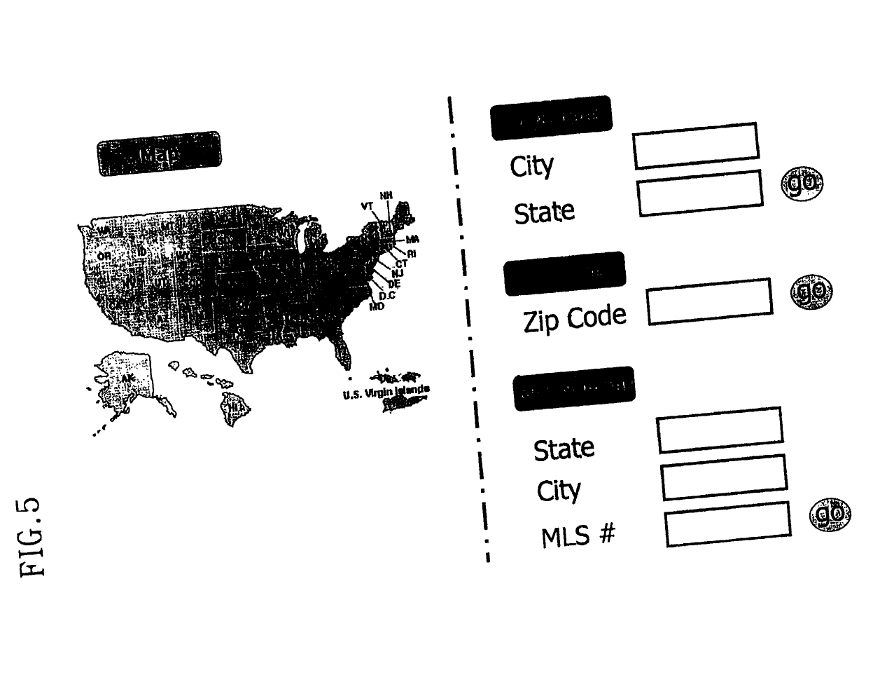

FIG. 5 to FIG. 9 are views for showing output screens appearing on a user web browser as an example of the information providing process of the information extraction agent system according to the first embodiment of the present invention.

FIG. 5 shows a screen appearing on a user web browser when a user connects to a wrapper server, and selects “Find a Home” to search real estate out of various search categories. In this screen, the user inputs searchable conditions and the like such as map, city, state, zip code, MLS number, and so on.

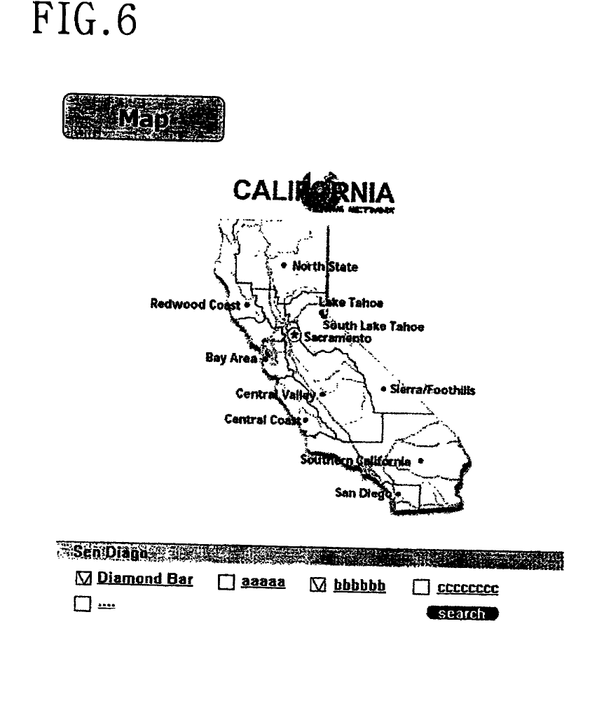

If one state is selected on the screen of FIG. 4, for example, CA (California state), a map of the California state appears on the user web browser as shown in FIG. 6. If the city of San Diego is selected on the screen of FIG. 6, various regions of this city appear as shown below the map, and the user selects regions the user wants from the various regions and then requests a search.

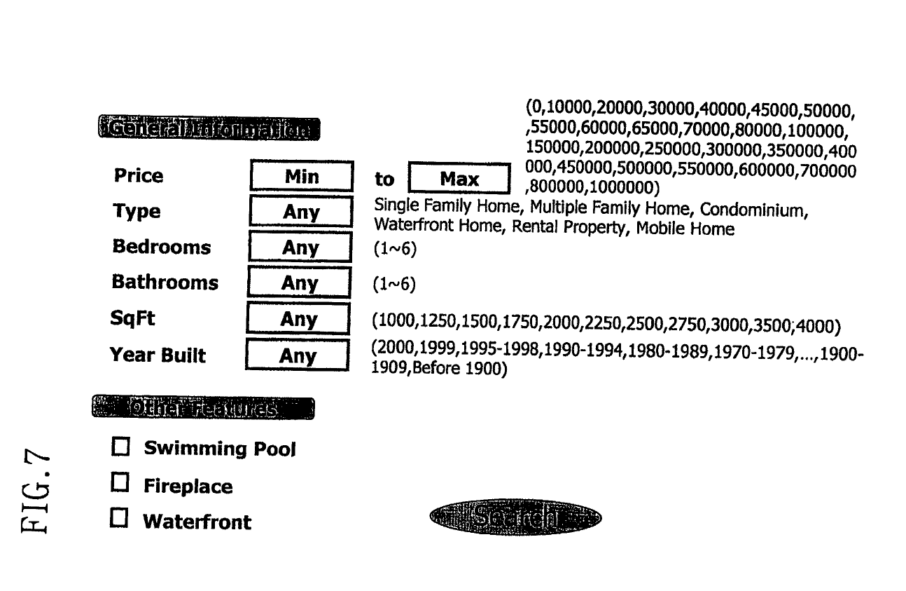

Next, as shown in FIG. 7, a screen appears on the users web browser for the user to input generally selectable conditions such as price, house type, the number of bedrooms, and so on and additionally selectable conditions such as swimming pool, waterfront, and so on, and the user inputs the conditions.

FIG. 5 to FIG. 7 show the steps from the information search request to the search condition inputs, of the user. After these inputs, the extraction of wrapper, the transfer of wrapper, a wrapper interpreter, output-producing unit, and web robot, the information collection of web robot, and so on, are carried out.

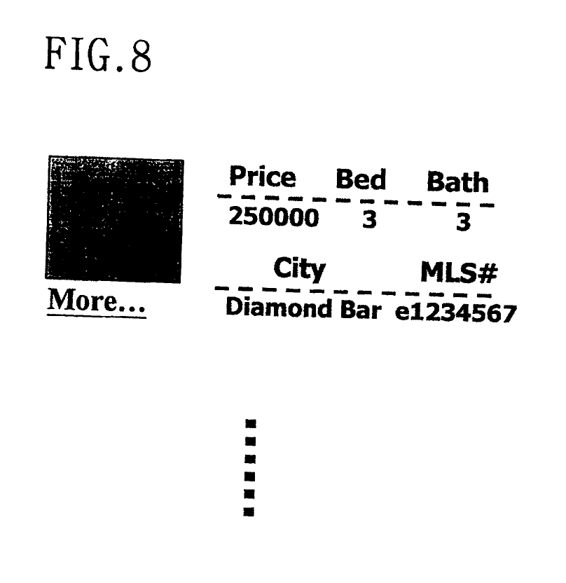

After these steps, a list of houses that fit the conditions selectively inputted in FIG. 5 to FIG. 7 is provided as in FIG. 8. The list form in FIG. 8 indicates that information from numerous sites of other companies has been processed. Since each piece of information is digital content and each digital content has its own copyright, when an information extraction agency directly brings such digital contents from the sites of other companies via its own wrapper server and provides them to users, the infringement of the copyrights may occur. However, in the present invention, the information extraction agency allows the user to directly bring the digital contents of other company's sites without going through its own wrapper server; thus, copyright infringement does not occur.

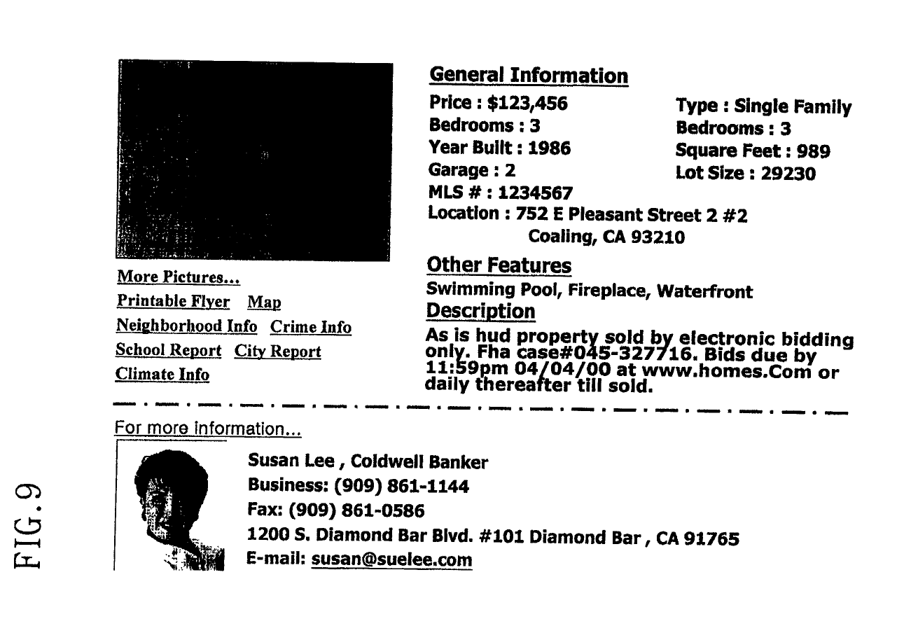

When the user requests detailed information by clicking on “More . . . ” hyperlink on the screen of FIG. 8, the detailed information on the selected house appears as in FIG. 9, and the screen becomes the same screen as that of the web site of one of the other companies.

In a second alternative embodiment of the instant invention, there is an information extraction agent system for providing a function of making the user select web sites that the user wishes to search in addition to the search condition when the user requests a search.

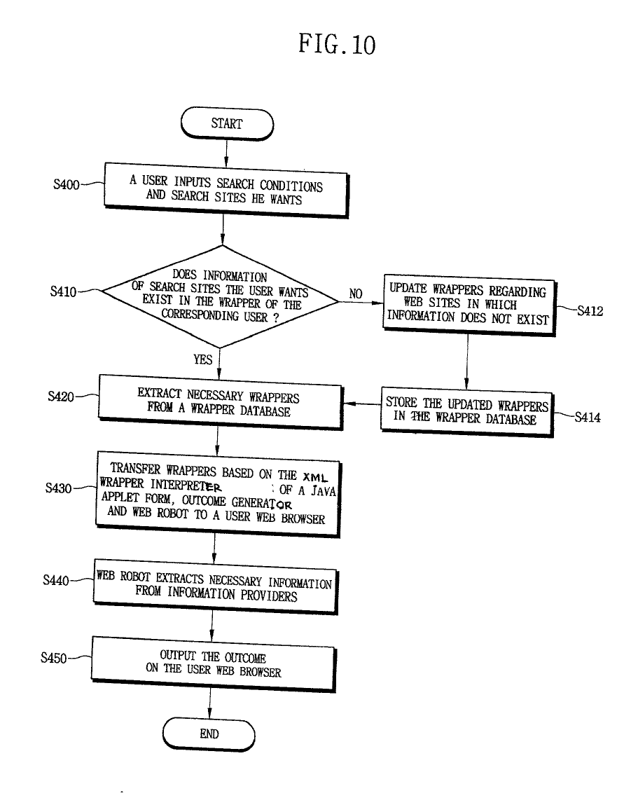

FIG. 10 is a flow chart for showing an information providing process of an information extraction agent system according to the second embodiment of the present invention.

A user connects to the wrapper server 220 and selects web sites for inputs he/she wants to search in addition to a search condition (S400).

Since the user does not input the web site information he/she wants to search in the first embodiment of the present invention, the wrapper regarding the user exists only with respect to the web sites that a wrapper server administrator has set. However, in the second embodiment of the present invention, since the user inputs web sites, the information on the web sites that the corresponding user inputs to the wrapper may not exist. Accordingly, a step S410 is necessary for judging whether the information on the web sites the user has inputted exists in the wrapper of the corresponding user.

In the step S410, if the information on the web sites that the user has inputted exists in the wrapper of the corresponding user, the additional updates of the wrapper is not needed, and the search and information providing process is completed, going through the steps S420, S430, S440, and S450 which are the same as those in the first embodiment of the present invention.

However, if the information on the web sites that the user has inputted does not exist in the wrapper of the corresponding user in the step S410, the wrapper of the corresponding user should be updated with respect to new web sites in which the information does not exist (S412). Next, the updated wrapper is stored in a wrapper database (S414), and the search and information providing process are completed, going through the steps S420, S430, S440, and S450.

The information extraction agent system according to the present invention does not enable the wrapper server to directly provide information, but only information extraction rules, and makes users handle information of actual information providers, so that it has an effect of overcoming the copyright infringement matters which may take place as the wrapper server for commercial purposes uses the digital contents of the web sites of other companies without permission.

Although the preferred embodiments of the present invention has been described, it will be understood by those skilled in the art that the present invention should not be limited to the described preferred embodiments, but various changes and modifications can be made within the spirit and scope of the present invention as defined by the appended claims.

What is claimed is:

1. A method for providing a user with information on the Internet, in an environment having a user web browser, one or more information providing web sites, and a wrapper server for controlling providing of an information the user wants from the information providing web sites to the user, comprising the steps of:
(a) receiving an information search request of the user and extracting wrappers regarding the user who makes the request from a database in which a plurality of wrappers are stored;
(b) transferring the wrappers regarding the user who makes the request, a web robot, and a wrapper interpreter capable of interpreting the wrappers and outputting an outcome to the user web browser;
(c) collecting the information the user wants from the information providing web sites by using the web robot in the user web browser; and
(d) making the collection information an outcome of a processed form and providing the outcome to the user by using the wrappers and the wrapper interpreter.

2. The method as claimed in claim 1, wherein, in case that the user has inputted information providing web sites the user wants to search and information on the information providing web sites the user wants does not exist in the wrappers in the receiving steps, the receiving step further comprising the steps of:
(a) updating the wrappers with respect to the information providing web sites in which the information does not exist; and
(b) storing the updated wrappers in the wrapper database.

3. The method as claimed in claim 1, wherein the information provided to the user is in a form of digital contents.

4. The method as claimed in claim 2, wherein the information provided to the user is in a form of digital contents.

5. The method as claimed in claim 1, wherein the web robot and the wrapper interpreter programs of java Applet forms.

6. The method as claimed in claim 2, wherein the web robot and the wrapper interpretation unit are programs of java Applet forms.

7. An information extraction agent system including a wrapper server having a storage device and a processor connected to the storage device, and for searching and providing an information a user wants on the Internet, the storage device comprising:
(a) a request receiver for receiving an information search request of the user and extracting a set of wrappers regarding the user who makes the request from a database in which the wrappers are stored;
(b) a transferor for transferring the wrappers regarding the user who makes the request, a web robot, and a wrapper interpreter capable of interpreting the wrappers and outputting an outcome to a user web browser;
(c) an information collector for collecting the information the user wants from the information providing web sites by using the web robot in the user web browser; and
(d) an outcome generator for making the collected information an outcome of a processed form and providing the outcome to the user by using the wrappers and the wrapper interpreter.

8. The information extraction agent system as claimed in claim 7, wherein, in case that the user has inputted information providing web sites the user wants to search and information on the information providing web sites the user wants does not exist in the wrappers regarding the user as the user requests the information search, the storage device further comprising:
(a) a wrapper generator for updating the wrappers with respect to the information providing web sites in which the information does not exist; and
(b) a wrapper keeper for storing the updated wrappers in the wrapper database.

9. The information extraction agent system as claimed in claim 7, wherein the information provided to the user is in a form of digital contents.

10. The information extraction agent system as claimed in claim 8, wherein the information provided to the user is in a form of digital contents.

11. The information extraction agent system as claimed in claim 7, wherein the web robot and the means capable of interpreting the wrappers and outputting the outcome are programs of java Applet forms.

12. The information extraction agent system as claimed in claim 8, wherein the web robot and the wrapper interpreter capable of interpreting the wrappers and outputting the outcome are programs of java Applet forms.
